(19) United States
(12) Patent Application Publication
(10) Pub. No.: US 2025/0297566 A1
(43) Pub. Date: Sep. 25, 2025

(54) SYSTEM AND METHOD FOR AUTOMATICALLY ESTIMATING GAS EMISSION PARAMETERS

(71) Applicant: Geolabe LLC, Los Alamos, NM (US)

(72) Inventor: BERTRAND ROUET-LEDUC, Los Alamos, NM (US)

(21) Appl. No.: 18/868,644

(22) PCT Filed: Mar. 27, 2023
(86) PCT No.: PCT/US2023/016355

§ 371 Date: Nov. 22, 2024

Related U.S. Application Data
(60) Provisional application No. 63/345,910, filed on May 26, 2022.

(51) Int. Cl. F01N 11/00; G06N 3/08

(52) U.S. Cl. CPC F01N 11/00; G06N 3/08; F01N 2560/02; F01N 2900/0416

(57) ABSTRACT

The present disclosure relates a technique for determining gas emission parameters over a geospatial area. The system includes a non-transitory computer-readable medium for storing the spectral signals obtained from overhead sensors and one or more trained deep-learning classification models. The system further includes one or more processors configured to determine one or more gas emission parameters over the geospatial area based on the one or more spectral signals using the one or more trained deep-learning classification models. Each of the one or more trained deep-learning classification models is generated by generating training data based on training samples representative of spectral signals from the one or more geospatial areas at two or more different time-periods, forming a set of training data batches, and training a deep-learning classification model based on the set of training data batches by applying an iterative optimization procedure to adjust hyperparameters of the deep learning classification model.

### PRIORITY PARAGRAPH

This application claims priority to the U.S. provisional application 63/345,910 filed on May 26, 2022 titled “Apparatus, method, and system for automatically estimating gas emission signals”, which is fully incorporated herein by reference.

### TECHNICAL FIELD

The present disclosure generally relates to a method and a system for detecting and estimating gas emission parameters within a geospatial area.

### BACKGROUND

The monitoring and detection of gas emissions from various sources (including but not limited to natural sources, industrial activities, oil and gas extraction transport and storage activities, waste facilities, or agriculture) are coming into the spotlight due to their impact on climate change. Worldwide, governments and companies are gradually taking measures for reducing greenhouse gas emissions and curb global warming. Greenhouse gas emissions are increasingly targeted by regulatory authorities, or various government bodies, thus highlighting the need for improved measurements and monitoring, which can be useful for operational purposes, for informing policies, and for complying with existing regulations. Amongst these gases, methane and carbon dioxide are the most widely produced gases and are often released as a byproduct of various industrial, agricultural, or other small-scale processes.

Despite the awareness, these gas emissions may be difficult to detect and quantify, especially in regions with little instrumentation. Currently, existing methods typically lead to low spatial and temporal resolutions and may be limited to pre-selected areas of interest with little generalization possible to new types of sources.

Currently available processes for monitoring gas emissions have significant drawbacks, due to the lack of specificity and accuracy of existing detection methods. Further, most available approaches are based upon total column concentration maps, which are limited to some types of sensors and introduce intermediate computation steps.

There is, therefore, a need in the present state of the art for accurate monitoring of gas emissions globally, using methods that can handle the staggering amount of data generated by the existing and upcoming remote spectral sensors. Also, there is a need for a system that can be deployed over large regions, or even over the entire Earth, and that can measure at high resolutions, and with which the monitoring can be automatized. Further, a need exists in the art for efficient methods to combine data from various sensors to obtain more precise, more frequent, as well as accurate measurements of gas emission parameters.

### SUMMARY

In an embodiment, a method for determining gas emission parameters over a geospatial area is disclosed. The method includes obtaining, by a computing node and from one or more overhead sensors, one or more spectral signals over the geospatial area in three or more different spectral bands and at two or more different time-periods. The method further includes determining, by the computing node, one or more gas emission parameters over the geospatial area based on the one or more spectral signals using one or more trained deep-learning classification models. Each of the one or more trained deep-learning classification models is generated by generating training data based on training samples representative of historical spectral signals from one or more geospatial areas. The training samples of the present method comprise one or more positive samples representative of a presence of gas emissions and zero or more negative samples representative of an absence of gas emissions. Each of the one or more trained deep-learning classification models is generated by forming a set of training data batches, wherein each training data batch comprises a part of the training data. Each of the one or more trained deep-learning classification models is generated by training a deep-learning classification model based on the set of training data batches; wherein the training comprises applying an iterative optimization procedure on one or more of the set of training data batches to adjust hyperparameters of the deep learning classification model such that a loss metric of the application of the trained deep learning classification model on the training data is minimized or maximized.

In another embodiment, one or more spectral signals comprises one or more of the reflectance signals, absorbance signals, radiance signals, transmittance signals, a ratio of reflectance signals in different spectral bands, a ratio of radiance signals in different spectral bands, a ratio of absorbance signals in different spectral bands, a temporal variation, spatial variation, or spectral variation of one or more of reflectance signals, absorbance signals, radiance signals, transmittance signals, a ratio of reflectance signals in different spectral bands, a ratio of radiance signals in different spectral bands, a ratio of absorbance signals in different spectral bands or a combination thereof.

In another embodiment, the one or more spectral signals correspond to a time series of spectral signals or a temporal difference of spectral signals.

In another embodiment, the positive samples include synthetic positive samples generated by superimposing simulated gas emissions to one or more of the negative samples.

In another embodiment, the one or more gas parameters is selected from at least one of a reflectance, a radiance, an absorbance, a transmittance, a gas spatial distribution, a source location for gas emissions, a mass, a volume, a gas emission rate, a gas concentration, or a temporal or a spatial variation thereof.

In another embodiment, the training samples are pre-processed to extract signal parameters or features, wherein the pre-processing further includes applying at least one of normalization, a cropping, a rotation, a noise addition, an embedding, a denoising, a filtering, a statistical ratio, a density estimation, a differentiation analysis, a translation of the spectral signal, or another non-linear operation thereof.

In another embodiment, the training data further comprises auxiliary data, wherein the auxiliary data is selected from at least one of the data from the spectral signal obtained at a different time, data from a different spectral signal, topography data, weather data, wind data, cloud data, digital elevation model, thermal data, optical data, albedo data, SAR data, or InSAR data, bottom-of-atmosphere reflectance data, or a time series thereof. By way of non-limiting example, auxiliary data can also include combinations of spectral signals aimed at enhancing the spectral signature of two or more specific gases such as methane and water vapor.

In another embodiment, rendering one or more gas emission parameters to a user via a graphic user interface (GUI), a message notification, or an alert, wherein the alert or the message notification is generated based on a value of at least one of the one or more gas parameters.

In another embodiment, the type of output of each of the deep learning classification models is a scalar, an image, a distribution, a probability, an error, a map, a time series, a graph, or a mask.

In another embodiment, the one or more overhead sensors is mounted on an overhead device selected from at least one of a multi-spectral satellite or a hyperspectral satellite, a drone, a balloon, a plane, an unmanned aircraft, an unmanned aerial vehicle, a remotely piloted vehicle, an uncrewed aerial vehicle, an unmanned spaceship, or any other macro or micro air vehicles thereof.

In another embodiment, a system for determining gas emission parameters over a geospatial area is disclosed. The system further includes a non-transitory computer-readable media for storing one or more spectral signals received from one or more overhead sensors over the geospatial area at two or more different time-periods, and one or more trained deep-learning classification models. The system further includes processor-executable instructions and at least one computing node comprising one or more processors wherein the at least one computing node is operatively coupled to the non-transitory computer-readable medium. The system further includes processor-executable instructions which when executed by the one or more processors caused the one or more processors to determine one or more gas emission parameters over the geospatial area based on one or more spectral signals using one or more trained deep-learning classification models. The system further includes each of the one or more trained deep-learning classification models are generated by generating training data based on the training samples representative of historical spectral signals from one or more geospatial areas. The system further includes training samples comprising one or more positive samples representative of a presence of gas emissions and zero or more negative samples representative of the absence of gas emissions. The system further includes forming a set of training data batches, wherein each training data batch comprises a part of the training data. The system further includes training deep-learning classification model based on the set of training data batches, wherein the training comprises applying an iterative optimization procedure on one or more of the set of training data batches to adjust hyperparameters of the deep learning classification model such that a loss metric of the application of the trained deep learning classification model on the training data is minimized.

In another embodiment, the one or more spectral signals are measured at one or more different wavelengths, and wherein the spectral signals correspond to one or more of a time series of spectral signals or a temporal difference of spectral signals. In another embodiment, the positive samples comprise synthetic positive samples generated by superimposing simulated gas emission to one or more of the negative samples.

In another embodiment, the one or more gas parameters is selected from at least one of a reflectance, a radiance, an absorbance, a transmittance, a gas spatial distribution, a source location for gas emissions, a mass, a volume, a gas emission rate, a gas concentration, or a temporal or a spatial variation thereof.

In another embodiment, the system further a user device to render the one or more gas emission parameters to a user via a graphic user interface (GUI), a message notification, or an alert, and wherein the alert or the message notification is generated based on a value of at least one of the one or more gas parameters.

It is to be understood that both the foregoing general description and the following detailed description are exemplary and explanatory only and are not restrictive of the invention, as claimed.

### BRIEF DESCRIPTION OF DRAWINGS

FIG. 1A illustrates a schematic of a geospatial area of interest, in accordance with various embodiments of the present disclosure.

FIG. 1B illustrates a flow diagram depicting a method for collecting spectral signals, in accordance with an embodiment of the present disclosure.

FIG. 2 illustrates a flow diagram depicting an exemplary method for generating a classifier, by an embodiment of the present disclosure.

FIG. 3 illustrates a flow diagram depicting a method for using a trained classifier, by an embodiment of the present disclosure.

FIG. 4 illustrates a flow diagram depicting an exemplary system for estimating a gas parameter from spectral signals in accordance with an embodiment of the present disclosure.

FIG. 5 illustrates the flow diagrams depicting exemplary methods for training and evaluating a classifier, in accordance with an embodiment of the present disclosure.

FIG. 6 illustrates a flow diagram depicting an exemplary use of a trained classifier, in accordance with an embodiment of the present disclosure.

FIG. 7A illustrates an exemplary graphical representation depicting the application of a trained classifier for separating gas absorption signals when mixed with irrelevant noise signals, measured over a geospatial area of interest, in accordance with an embodiment of the present disclosure.

FIG. 7B illustrates a graph depicting the application of the trained classifier for correctly detecting a gas leak over a geospatial area of interest, in accordance with an embodiment of the present disclosure.

FIG. 7C illustrates a graph depicting the application of the trained classifier to sensor signals received from a different overhead sensor, in accordance with an embodiment of the present disclosure.

FIGS. 8A-8C illustrates various graphs depicting the applications of the trained classifier to sensor signals received on a different date, in accordance with an embodiment of the present disclosure.

FIG. 9 illustrates a graph showing the application of the trained classifier for estimating an emission rate and associated interval, in accordance with an embodiment of the present disclosure.

FIG. 10 illustrates a flow chart of an exemplary method for training a neural network classifier, in accordance with an embodiment of the present disclosure.

FIG. 11 illustrates a flowchart of an exemplary computing environment using which the disclosed method can be implemented, in accordance with an embodiment of the present disclosure.

The illustrations presented herein are merely idealized and/or schematic representations that are employed to describe embodiments of the present invention.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

As used herein, the term “gas emissions” refer to natural and man-made greenhouse gas emissions within a region of interest. Sources of gas emissions include but are not limited to anthropogenic sources such as agriculture, livestock, wastewater treatment plants, industrial waste, oil & gas extraction, oil & gas storage, oil & gas transport, oil & gas refining, power plants, fossil fuel combustion, atmospheric deposition, landfills or mines, and natural sources such as wetlands, permafrost, termites, and ocean processes. The source of gas emissions may be located within a “geospatial area” of interest. By way of non-limiting examples, a gas emission may be a methane leak from an oil and gas extraction field, or from an oil and gas storage reservoir, or methane escaping from an unlit or poorly lit gas flare. As used herein, the term “synthetic gas emission” refers to a gas emission simulated by a physical or numerical model, including but not limited to a Gaussian model or a Large Eddy Simulation model, or any suitable model thereof. A “synthetic gas emission” also refers to a gas emission generated by a machine learning model trained to generate gas emission signals from examples of real gas emission signals data, including but not limited to generative adversarial networks. A “synthetic gas emission” also refers to a procedure to generate a large set of gas emissions from a smaller set of real or synthetic examples of gas emission through linear or non-linear operations including but not limited to one or more of a translation, a rotation, an upsampling, a downsampling, a resizing, or a rescaling.

As used herein, the term “geospatial area” refers to any geographical region of interest on the surface of the Earth, and the atmosphere above the same region.

As used herein, the term “source” refers to the temporal and spatial origin of the gas emission, including “point sources” and “non-point sources”. “Point sources” are the ones where the gas emission is localized, for example, when the point of source of gas emission is less than 5 meters in scale. Whereas the “non-point sources” typically mean a source when the gas emission is spatially diffused and its origin cannot be attributed to a single spatial point, for example, when the gas is emitted from an area of at least 5 meters in scale, and including transient and non-transient sources. Point sources can be described by a single point of geographical latitude and longitude coordinates, whereas non-point sources can only be described by a region defined by a set of several geographical latitudes and longitude coordinates. By the way of non-limiting examples, a point source may correspond to a piece of equipment in a facility or any infrastructure (such as a compressor, a pump, a well, etc.), while a non-point source may refer to a piece of wetland, a wastewater facility, a landfill, etc. A transient source may correspond to a sudden leak from an industrial piece of equipment. A non-transient source may correspond to a gas continuously emitting from the decomposition of a landfill or from a mine shaft, an unlit gas flare, etc.

As used herein, the term “spectral” signals refer to spectral imaging signals, measuring the light intensity (including but not limited to reflectance, radiance, absorbance, or transmittance signals) in several different wavelengths, generally covering the electromagnetic spectrum from the ultra-violet to the visible to the infrared, with a focus on short-wavelength infrared where spectral signatures of gases of interest are most marked. Images can be divided into continuous or discrete spectral bands. Spectral signals of interest include broadband imaging signals corresponding to continuous spectra, hyperspectral imaging signals corresponding to near-continuous spectral bands, and multispectral imaging signals corresponding to discrete spectral bands. “Synthetic spectral signals” refer to spectral signals that have been superimposed with spectral signatures of a synthetic gas emission, using a physical or numerical model such as the Beer-Lambert law.

As used herein, the term “bands” refers to hyperspectral or multispectral spectral bands which are characterized by the wavelengths that they encompass and between which a light intensity received by the sensor is measured.

As used herein, the term “transmittance” at a given wavelength, refers to the fraction of light transmitted when passing through a material.

As used herein the term, “absorbance” refers to the negative logarithm of transmittance.

As used herein, the term “reflectance” refers to the ratio of the light flux reflected off a surface to the incident light flux arriving at said surface. Of particular interest is the term “top of the atmosphere reflectance” which considers the Earth's surface and its atmosphere as a reflecting object concerning the light from the sun, which spectrum is used as reference.

As used herein, the term “radiance” refers to the light flux radiating from a surface, per unit of surface area.

As used herein, the term “concentration” typically refers to a gas concentration which is an indication of how much of a gas is present at a certain time and at a certain location, in terms of mass or quantity per unit volume.

As used herein, the term “sample” refers to one or more spectral signals or a time series of spectral signals over an area of interest, and may refer to any combination of raw signals, processed signals, or parameters or features extracted therefrom.

It can be useful to distinguish samples into (A) samples containing signatures of gas emissions, which are termed “positive samples”, (B) samples containing signatures of synthetic gas emissions, which are termed “synthetic positive samples”, and (C) samples devoid of any signatures of gas emissions, termed as “negative samples”.

As used herein, the term “classification” refers to a process of generating computer-implemented classes. When a training sample is associated with a specific type or a category, it is generally termed a one-dimensional classification. The training sample may also represent any historical data or may constitute historical spectral signals. Similarly, if the sample is associated with several categories or more than one class, then it is termed a multi-dimensional classification. The category or categories to be classified are generally denoted as the sample's “class” or “label”. Classification can be binary (two different output classes), multi-modal (discrete number of output classes greater than two), or continuous. Classification in terms of continuous output classes is typically termed “regression”. As used herein, classification encompasses both discrete and continuous classification (“classification” and “regression”).

As used herein, the term “class” refers to a set of continuous or categorical values whose size is arbitrary. It includes but is not limited to, a single continuous value, a single categorical value, a set of continuous values associated with a scalar, an image, a mask, a graph, a probability, an error, a map, a time series or a distribution, a set of categorical values associated with a scalar, an image, a mask, a graph, a probability, an error, a map, a time series or a distribution.

As disclosed herein, the term “classifier” refers to a computer-implemented algorithm or a computer-implemented model, that can accept one or more of sample inputs or sample signals and produce an output class corresponding to the class of the one or more input samples or sample signals. A classifier corresponds to a deep learning classification model. Classifiers may encompass trained machine learning models that render an output as an image, a tensor, or a distribution of continuous or discrete values, including but not limited to auto-encoders, transformers, convolutional neural networks, dense neural networks, etc. The classifiers may produce continuous output classes, including but not limited to scalars, images, masks, graphs, probabilities, errors, maps, time series or distributions of discrete or continuous values.

As used herein, the term “optimization” refers to a procedure evaluating a plurality of configurations or hyperparameters and selecting any one configuration or parameter according to a preselected criterion. By way of a non-limiting example, the preselected criterion can include a maximum value or a minimum value, and the associated optimization procedures corresponding to the “maximization” and “minimization” functions. An optimization procedure can be halted or stopped after a specified time or a specified volume of data is gathered, or when the preselected criterion is satisfied, and can successfully finish without finding an exact or global optimum. A person skilled in the art will understand that optimization, minimization, and maximization refer to any method that attends to find an item or set of items to achieve superior performance, as measured by an evaluation metric. It is understood that such optimization does not necessarily lead to perfect outputs and can be achieved by a grid-based search among possible item values, or by varying item values as a function of performance, such as gradient-based optimization methods.

As used herein, the term “remote overhead sensor” refers to a movable overhead device configured to measure the physical characteristics of an object such as the location of an object, shape of the object, object spectrum, etc., without coming into direct physical contact with the object. Remote overhead sensors comprise overhead acquisition devices such as satellites, airplanes, drones, balloons, remotely operated vehicles, unmanned vehicles, etc. Remote sensors may further include, but are not limited to, NASA's OCO-2 and OCO-3 satellites, USGS-NASA's Landsat 8 and 9 satellites, ESA's Copernicus Sentinel-2 or Sentinel-5P satellites, JAXA's GOSAT satellite, or ASI's PRISMA satellite, or any other satellite available thereof.

As used herein, the term “loss metric” refers to the computation of a loss function or statistic, that evaluates the badness of fit of the model evaluated by the loss function to a set of samples. The loss metric can generally be any function that is anti-correlated to a “performance metric” that measures how good the model is performing on the samples, and one skilled in the art will understand that the minimization of a loss metric is the same as maximizing a performance metric. By way of non-limiting examples, the loss function can evaluate the badness of fit from the mean squared errors or the mean absolute errors that result from applying the model on the samples, or by the average cross-entropy that results from applying the model on the samples.

As used herein, the term “deep learning classifier” refers to deep learning architectures that have been trained to perform operations including, but not limited to, classification, regression, or denoising tasks. A deep learning classifier is a neural network composed of a plurality of artificial neurons, that can be organized as graph nodes or layers, where except for the last graph node or layer, the remaining graph nodes or layers may be operable for receiving samples and applying one or more successive embeddings or filters or non-linear operations to said samples. The last layer of artificial neurons is operable to generate an estimate of the atmospheric gas emission parameter. By way of non-limiting examples, the type of the estimate generated by the classifier can include one or more of a scalar, an image, a distribution, a probability, an error, a map, a time series, a graph, or a mask.

The present disclosure applies to all gas emission sources or geospatial areas where it is desired to monitor and detect gas emissions. The disclosure demonstrates the use of a classifier to estimate gas emission parameters using spectral signals captured over a geospatial area of interest and at two or more different dates. For capturing the spectral signals, one or more overhead remote sensors as previously described herein, are used which are deployed over the geospatial area of interest where the monitoring of gas emission parameters is required. The gas emission parameters may include but are not limited to a gas-induced change in radiance, absorbance, reflectance or transmittance, or a concentration, or emission rates.

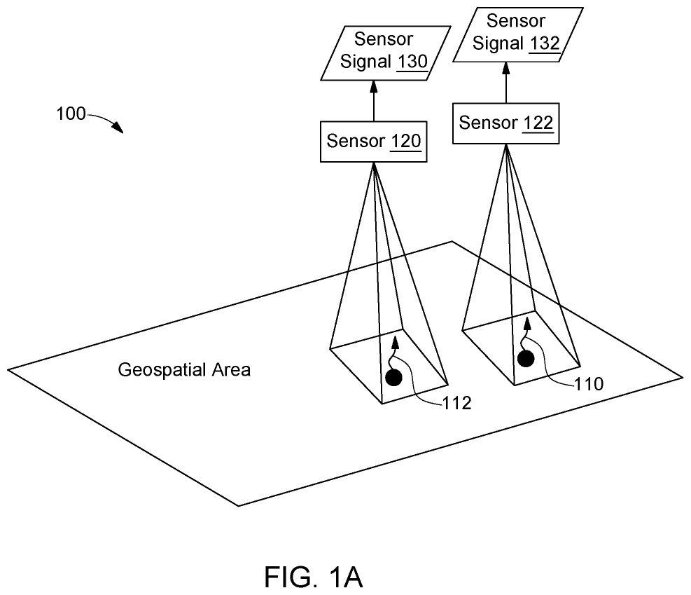

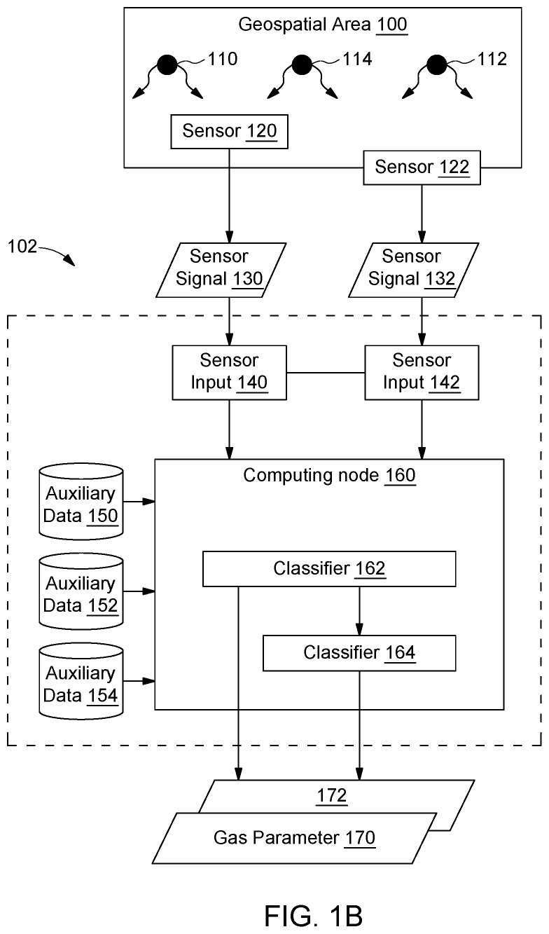

Referring now to FIG. 1A, an exemplary geospatial area 100 is illustrated, in accordance with various embodiments of the present disclosure. The geospatial area of interest 100 may for example be any geographical region of interest on Earth's surface. In an embodiment, one or more overhead sensors 120, 122, may be configured over and above the geospatial area of interest 100, for capturing one or more spectral signals 130, 132, relating to one or more gas emissions 110, 112. The overhead sensors 120, and 122 are generally remote sensors that are configured to capture spectral signals 130, and 132, over a geospatial area 100 generally from a distance. The remotely placed overhead sensors are configured to detect and monitor various gas emissions.

The remote sensors by estimating the reflected and emitted radiation from a distance transmit the signals as input for further processing by a computing system. The signals thus transmitted by the remote sensors 120, 122, are spectral signals or sensor signals representing lights reflecting from the surface of the Earth (i.e., a geospatial area), in a form including but not limited to reflectance, absorbance, transmittance, or radiance, measured at various wavelengths.

Referring now to FIG. 1B, illustrating a schematic of method 102 for collecting spectral signals, in accordance with an embodiment of the present disclosure. In an embodiment, the feasibility of estimating the gas emission parameters by directly applying a classifier to spectral signals is disclosed. One or more classifiers 162, and 164 are generated for estimating gas emission parameters based on spectral signals collected by the overhead sensors 120, and 122. In an embodiment, one or more spectral signals 130, 132 may be collected from the geospatial area 100 where one or more gas emissions 110, 112, 114 may occur. The collected spectral signals are stored on a computer-readable device such as a computing node 160.

In some embodiments, the gas emissions 110, 112, and 114, may occur at any specific time or from any specific location over the geospatial area 100. Typically, the gases of interest may include but are not limited to carbon dioxide (CO₂) and methane (CH₄). Further, it is understood that, although the present embodiments focus typically on CO₂ and CH₄, the present principles may be applied to any type of gaseous emission by collecting spectral signals appropriate to the gas of interest.

The overhead sensors 120, and 122, are coupled to sensor inputs 140, and 142, for providing the sensor signals 130, and 132, to the computing node 160. The spectral signals 130, and 132, thus travels through the sensor inputs 140, and 142 to the computing node 160. Sensor inputs 140, and 142, may directly or indirectly be connected to the computing node 160. In an embodiment, one or more auxiliary data 150, 152, 154 in the form of an additional input may be received at the computing node. Further, the computing node 160 incorporates one or more processors with a memory coupled thereto. Typically, the computing node is configured to classify the spectral signals using one or more classifiers 162, and 164. The classifiers 162, and 164, generate an output corresponding to an input signal, in the form of estimated gas emission parameters 170, and 172 respectively.

In an embodiment, the auxiliary data may include but is not limited to data from the spectral signal obtained at a different time, data from a different spectral signal, topography data, weather data, wind data, cloud data, digital elevation model, thermal data, optical data, albedo data, SAR data, or InSAR data, or bottom-of-atmosphere reflectance data, or a time series data thereof. SAR typically refers to synthetic aperture radar, obtained by a method or a system that derives radar backscattering amplitude and phase from active radar sensors. Alternatively, InSAR typically refers to interferometric synthetic aperture radar, obtained by a method or a system that derives phase change in the returning radar wavefield from several SAR acquisitions.

In some embodiments, changes in spectral signals may occur unevenly in the spectral domain over a geospatial area of interest where gas emissions 110, and 112 are contained. Typically, the signals of interest correspond to the gases of interest preferably absorbing light transmitted at specific wavelengths. Amongst the multiple spectral signals, a few spectral signals having wavelengths intersecting infrared short-waves may contain few gas emissions. The gas emissions 110, and 112 may partially or completely absorb spectral signals 130, and 132 at specific wavelengths that are characteristic of the gas species. Spectral signals which do not intersect with any gas emissions, are generally devoid of gas emission signals but may contain spectral signals from other objects or phenomena (such as roads, buildings, fields, some natural surfaces, variations in soil moisture, other gases than that of interest such as water vapor, etc.). The classifiers are thus trained, to distinguish between the gas emission spectral signals from the spectral signals coming from other objects and phenomena that are captured by the spectral sensor.

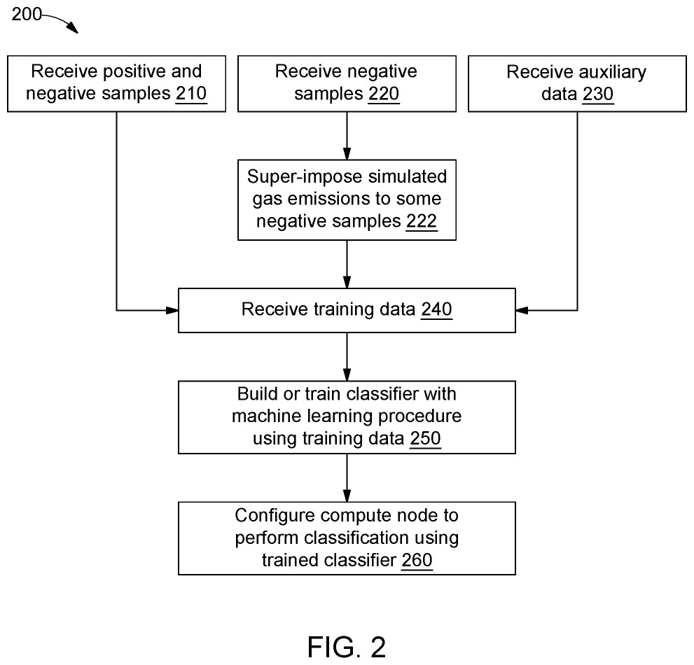

Referring now to FIG. 2, a detailed method for generating a classifier is illustrated via flowchart 200, by an embodiment of the present disclosure. The spectral signals forming one or more samples such as positive samples, negative samples, or synthetic positive samples thereof, may be used as exemplary training samples. Thus, the training samples may include one or more positive samples representative of gas emissions or zero or more negative samples without any signatures of gas emissions, or spectral signals from known gas emission events, or spectral signals generated from known gas emissions events being received at process block 210.

In addition to receiving one or more of the positive samples, and zero or more of the negative samples, some of the negative samples (out of the zero or more negative samples) may be received separately or additionally at process block 220. Further, the result of physical simulations of gas emissions may be super-imposed on some of the negative samples to create one or more of the “synthetic positive samples” received at process block 222. By the way of an example, the physical simulations may be performed by implementing one or more of a Gaussian plumes model, a large-scale Eddy simulation model, or any other such models thereof. The auxiliary data is simultaneously received as training auxiliary data at process block 230.

The negative samples as received may be zero or more because even when there is a gas signature embedded in an acquired satellite image, most of the image would still be seen without the gas, which is only present in a subset of the image. Therefore, in such scenarios, the training of the sample may be done with only the positive samples.

In an embodiment, the positive samples, synthetic positive samples, negative samples, and optionally the auxiliary data, may all be combined at process block 240 to form the training data. The training data may include any fraction of negative samples, positive samples and synthetic positive samples areas collected over two or more different time-periods. The training data may further be organized into subsets of samples, for example, single samples, multiple samples, or time series of samples thereof.

In an exemplary embodiment, the training data as organized into the subsets of multiple samples may further be implemented to provide accurate estimations and predictions, with a score or a metric evaluating this accuracy. By the way of an example, for more accurate estimations and predictions, the training data may be organized into the subsets of time series of the training samples. Optionally, the training data may be generated for a single geospatial area of interest, or the training data may be generated for several different geospatial areas.

It is noted by the present disclosure that the training samples or the training data received at process block 240, may be obtained from either the same spectral signals and the same geospatial areas of interest or it may be obtained from a different spectral signal and different geospatial areas of interest other than those disclosed elsewhere herein, to which the classifiers are to be applied for extracting gas emission parameters. Optionally, the training sample may be obtained as historical data of spectral signals.

Further to FIG. 2, at process block 250, a classifier is optionally trained or generated by implementing one or more machine learning procedures using the training data 240. The procedure for generating a classifier may vary according to the type of machine learning classifier. By way of an example, the machine learning classifier may be a deep learning model. By way of an example, the deep learning classifier may be trained by a machine learning procedure consisting of iteratively optimizing its performance on training data 240 by gradient descent, thereby maximizing its performance or minimizing its errors on the training data 240.

In an exemplary embodiment, an additional process block may optionally be applied between process blocks 240 and 250, to perform one or more of a normalization, translation, cropping, rotation, noise addition, embedding, denoising, filtering, statistical ratio, density estimation, differentiation analysis, or translation of the spectral signals, to extract signal parameters or features, or to perform any other linear and non-linear operations thereof.

The output of process block 250 is one or more trained classifiers. By the way of an example, one or more of the trained classifiers may typically correspond to one or more convolutional neural networks, dense neural networks, recurrent neural networks, graph neural networks, auto-encoders, or transformers.

At process block 260, one or more trained classifiers are used to configure a computing node to perform one or more classifications. In some examples, executable instructions embodying a trained classifier can be generated and stored. In additional examples, upon training, hyperparameters are identified and stored, which are made accessible by previously stored executable instructions embodying a trained classifier. The hyperparameters can encompass the layout of the trained classifier, while the parameters can encompass the details of the operations performed by the different elements laid out in the trained classifier.

As would be understood by the person skilled in the art, many variations may be possible in an embodiment of the present disclosure. A variety of one or more different classifier can be used, which can be trained or built at process block 250.

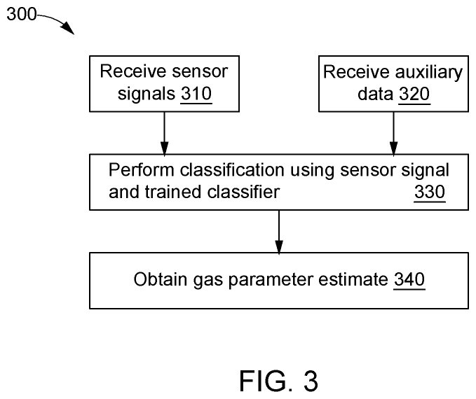

Referring now to FIG. 3, an exemplary method 300 for using a trained classifier to generate an estimation of gas emission parameters is illustrated via a flowchart by an embodiment of the present disclosure. The spectral signals are received at process block 310, and the associated auxiliary data (as disclosed herein) are optionally received at process block 320. The spectral signals and the auxiliary data are representative of the same processes, as described herein in FIG. 1A and FIG. 1B.

In an embodiment, the trained classifier may be used at process block 330 to perform one or more classifications using the collected spectral signals 310 and optionally using the auxiliary data 320. The trained classifier generates a classification output at process block 330 based on the input data. The classifier further implements the generated output at process block 330 to render an estimation of a gas emission parameter at process block 340.

In an exemplary embodiment, process block 330 may operate based on transformations of the spectral signals 310 detected by the remote overhead sensors (same as overhead sensors 120, 122). Typically, the transformations may be generated by performing a combination of linear and non-linear operations on the spectral signals 310.

In an exemplary embodiment, an additional process block may optionally be applied between process blocks 310, 320, and 330, to perform one or more of a normalization, translation, cropping, rotation, noise addition, embedding, denoising, filtering, statistical ratio, density estimation, differentiation analysis, or translation of the spectral signals, to extract signal parameters or features, or to perform any other linear and non-linear operations thereof. In another embodiment, an error or confidence metric may be generated based on the estimations of the gas emission parameters.

In an exemplary embodiment, it may so happen that an additional process block is required. The additional process block may optionally be configured between the process blocks 330 and 340. The requirement for the additional process block may originate when the spectral signals (to which the trained classifier is applied) represent gas emissions from a new geospatial area (for example, a geospatial area other than the area of interest 100) or when the spectral signals originate from different remote overhead sensors (for example, sensors other than provided overhead sensors 120, 122).

Hence, with the exemplary additional process block, atrained classifier may be applied to other geospatial areas of interest or other remote overhead sensors than those used to build the training samples. Further, the process of providing additional process blocks may include performing one or more scaling operations, quantile transforms, domain adaption, or other post-processing techniques thereof.

In some exemplary embodiments, it is disclosed that a classifier trained for spectral signals coming from specific geospatial areas and a specific satellite constellation may be applied to spectral signals coming from another geospatial areas or satellite constellation (for example, a classifier trained on signals received from Northern Algeria may be applied to spectral signals from Southern Algeria or California). By way of another example, the classifier trained on spectral signals received from Sentinel-2 satellite constellation may be applied to spectral signals received from the Landsat-8 satellite constellation.

As would be understood by the person skilled in the art, many variations are possible with the present disclosure such as the output of the classifier at process block 330 may directly correspond to the gas emission parameter of interest and in such a scenario, the process blocks 330 and 340 may be grouped to form one process block thereof.

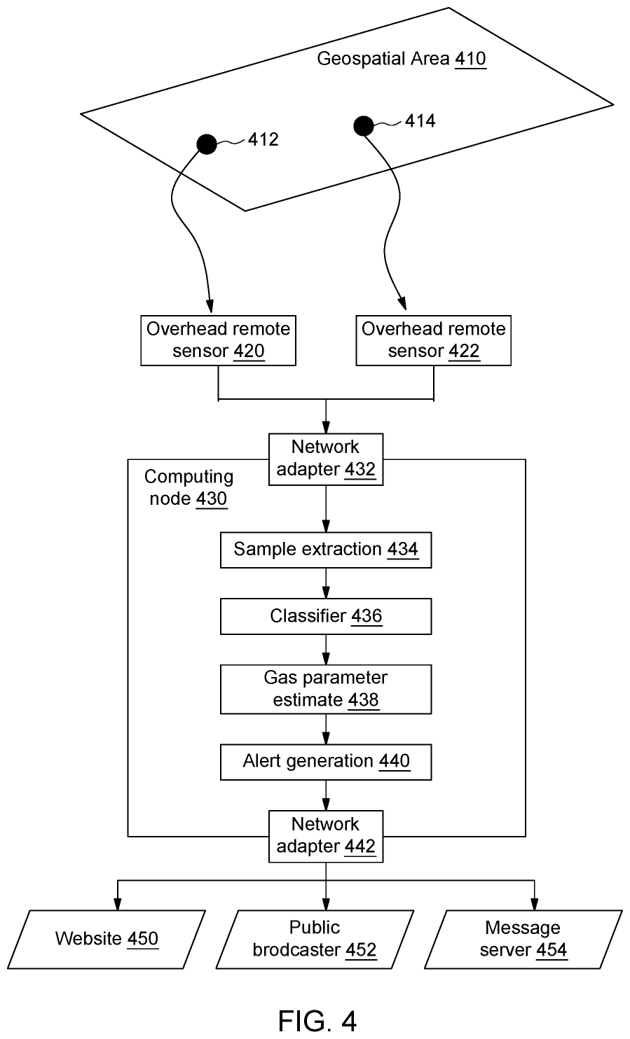

Referring now to FIG. 4, an exemplary system 400 is depicted via flowchart, by an embodiment of the present disclosure. The system 400 incorporates sensors 420, 422 (same as 120 and 122) and a computing node 430, for estimating a gas emission parameter representative of one or more gas emissions 412, 414, 416 occurring from an exemplary geospatial region 410 (same as geospatial area 100 as disclosed elsewhere herein).

The computing node 430 incorporates one or more processors coupled to a memory thereto. The overhead sensors 420, and 422 are coupled to computing node 430 through a network (not shown) and/or through one or more network adapters 432. The overhead sensors 420, and 422 receive spectral signals (not shown) of gas emissions from the geospatial area 410. The received spectral signals are communicated to the network adapters 432 from the overhead sensors. The network adapters 432 further transfer the spectral signals to the computing node 430.

The received spectral signals may form one or more samples of spectral signals including but not limited to, positive samples, synthetic positive samples, and/or negative samples, as may be described elsewhere herein.

In an embodiment, the computing node 430 may typically be configured to execute software instructions corresponding to one or more process blocks 434, 436, 438, 440, or a combination of process blocks, depicted as various software modules in FIG. 4 for performing various operations. Configuring the computer node to perform one or more classifications may include estimating and storing hyperparameters. These trained hyperparameters are accessible through executable instructions embodying a classifier or a trained classifier therein.

Process block 434 is configured to extract various samples (as disclosed above) from the received spectral signals. Further, process block 436 is configured to perform one or more classifications using one or more classifiers, on the samples of the spectral signals, extracted from process block 434. Additionally, process block 438 is configured to perform an estimation of one or more gas emission parameters based on the output of the sample classification.

In an embodiment, process block 440 is configured to generate an alert based on one or more values of the estimated gas emission parameters, thereby transmitting the generated alert to one or more destinations via a network (not shown) and/or via a network adapter 442. By the way of an example, the destinations may include one or more of a website or API 450, public broadcasting organization 452, or a message server 454 thereof.

In an alternative embodiment of the present disclosure, the estimated gas emission parameters may be used to generate an alert. The alert may be based on conditions, such as the estimated gas emission parameter exceeding a certain threshold. Further, the alerts may be generated in the form of a message including one or more of the time, location, source, volume, emission rate, or concentration of the analyzed gas emission, or a signal or a message transmitted to one or more of a website, an email server, a news organization, an annunciator, or a public institution or in any other form thereof. The alerts may be transmitted to one or more of the destinations as described herein.

In an exemplary embodiment, the output of applying the trained classifier may be broadcast by default, even in the absence of an alert, thereby providing a continuous monitoring of one or more areas of interest for gas emission parameters. In this monitoring mode, the transmission of the results of the detection as well as absence of detection by the trained classifier can be transmitted in the same manner as described in FIG. 4, via a network or a network adapter 442. By way of an example, the destinations may include but not limited to a website or API 450, a public broadcasting organization 452, or a message server 454, that makes a server accessible, for storing output or post-processed output of the trained classifiers.

In an exemplary embodiment, it may be possible that the destinations receiving an alert may republish the generated alerts by incorporating another network or another network adapter (not shown).

As would be understood by the person skilled in the art, many variations are possible with the present disclosure such as the overhead sensors 420, 22 may incorporate a processor with a memory coupled thereto to perform signal processing functions on one or more of the received spectral signals. These overhead sensors may receive spectral signals representative of the entire geospatial area of interest 410 or a fraction of the geospatial area of interest.

The received signals can be continuous or discretized (for example, including a discretization in a fixed number of spectral bands), and the signal path can include signal processing techniques such as digitization. The networks described herein can be one or more public or private networks, such as the internet or a telephone network. One or more receivers such as message server 454 may additionally be provided to be part of the disclosed system 400.

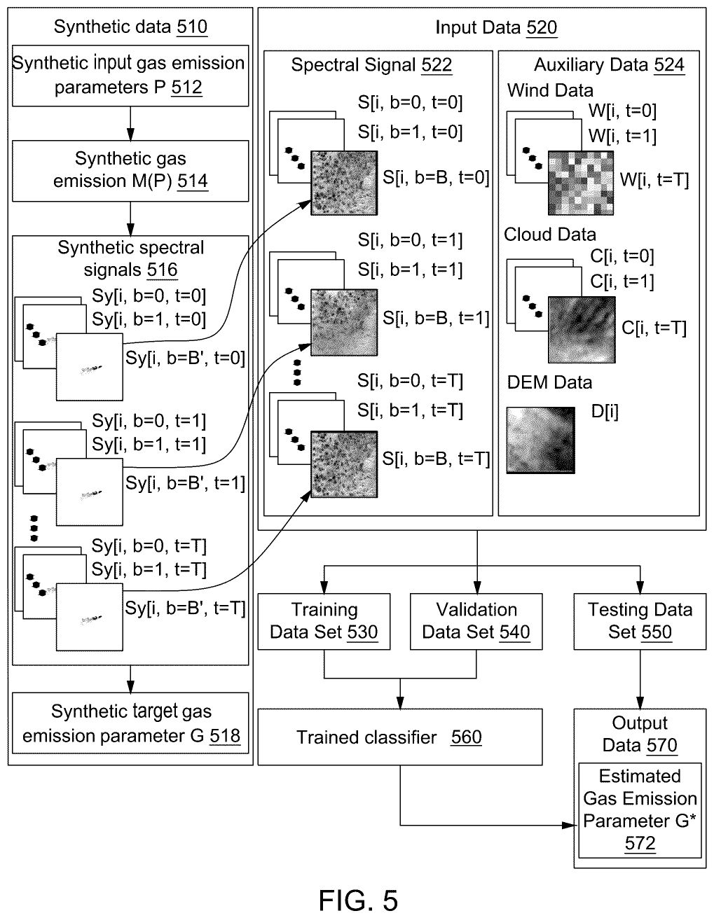

Referring now to FIG. 5, a detailed method for training and evaluation of a classifier is depicted in a flowchart, by an embodiment of the present disclosure. The method for generating synthetic spectral signals is illustrated. The synthetic spectral signal 510 denoted generally as Sy(i, b, t), is obtained. In the synthetic spectral signal 510 Sy(i, b, t), where the index i correspond to the index of the sample, the index i may vary as i=0 . . . , I, with I, being a positive integer. Another index b corresponds to the index of the spectral band, where b corresponds to the index of the spectral band and may vary from b=0 , . . . , B′, with B′ a positive integer; similarly, the index t corresponds to the index of the time series, t=0, . . . , T, with T a positive integer equal or greater than one.

In an exemplary embodiment, the synthetic spectral signals Sy(i, b, t) may be generated using at least one of the following techniques such as by selecting synthetic gas emission parameters P 512 and simulating the associated synthetic gas emissions M(P)(i,t) 514, or by using a physical or numerical model directly generating simulated synthetic gas emissions M(P)(i,t), for a time series of length T. The simulated synthetic gas emissions M(P)(i,t) is then transformed into synthetic spectral signals Sy(i,b,t) 516, using a physical or a numerical model, such as the Beer-Lambert law.

Further, by way of a non-limiting example, the physical numerical model that is used to generate synthetic gas emissions M(P)(i,t) may include but is not limited to, a Gaussian plumes model or a large-scale Eddy simulation model, or any other model thereof, including machine learning models such as generative adversarial networks. It is noted that the synthetic gas emission parameters 518 of interest like ‘G’, may correspond to any emission parameter derived from P, M(P), or Sy(i,b,t).

In an exemplary embodiment, the synthetic spectral signals 516 may correspond to reflectance, radiance, transmittance, or absorbance signals representative of the gas emissions. By way of non-limiting example, the synthetic gas emission parameters P 512 may be the rate (kilo of gas leaked per hour) and location of a methane leak, M(P) may be the resulting simulated plume that describes the spatial and temporal extent of methane concentration, and Sy is the reduced reflectance in spectral bands that overlap the absorption of methane and that results from integrating the synthetic methane plume in the spectral data using for example the Beer-Lambert law. The gas emission parameters of interest that the classifier is trained to retrieve can be any one of P, M(P) or Sy, for example, a map of the reduced reflectance that is only due to the methane plume.

Further, input data 520 received from various sources is illustrated. The input data 520 is used to train one or more classifiers. The input data 520, further includes spectral signals 522 and optionally includes auxiliary data 524. Further, the spectral signals 522 may be denoted as S(i, b, t), which are received from an overhead remote sensor (same as 120, 122). The spectral signals S(i, b, t), with b=0, . . . ,B spectral bands (where B is positive and may be discrete or continuous), over a time series of the same length T, may be provided as input signals.

Further, the time series of the synthetic spectral signals Sy(i,b,t), at t=0, . . . , T, is added to zero or more of the spectral signals S(i,b,t) of the corresponding times t to create synthetic positive samples. It may be noted that the synthetic spectral signals Sy(i,b,t) and the spectral signals S(i,b,t) may have different numbers of spectral bands. As an alternative to synthetic positive samples, positive samples associated with received spectral signals representative of known gas emissions with known gas emission parameters G may be used, including gas emissions parameters generated from combinations made from a set of known gas emissions. Further, negative samples associated to receive spectral signals not representative of specific gas emissions may also be used.

Auxiliary data 524 may optionally be used in combination to the spectral signals 522 to train one or more classifiers. The auxiliary data 524 may, for example, correspond to wind data W(i,t), t=1 . . . , T, cloud coverage C(i,t), t=1 . . . , T, and/or a digital elevation model data or any other data from different sources may be considered (not shown). The auxiliary data 524 (as described elsewhere herein) may include but is not limited to data from the spectral signal obtained at a different time, data from a different spectral signal, topography data, weather data, wind data, cloud data, digital elevation model, thermal data, optical data, albedo data, SAR data, or InSAR data, or bottom-of-atmosphere reflectance data, or a time series thereof.

Further, the synthetic positive samples, positive samples, negative samples, optional auxiliary data, and the corresponding gas emission parameters G are subdivided into three distinct, non-overlapping datasets which may be used to train and evaluate one or more classifiers. The three distinct, and non-overlapping datasets: training data set 530, validation data set 540, and testing data set 550 are shown. The synthetic positive samples, the positive samples, the negative samples, and the auxiliary data which may be contained in the training data set 530 in any combination, forms the combined input data for the classifiers.

Further, the one or more classifiers may be implemented using any trained artificial neural network 560. The corresponding gas emission parameters G are the desired output 570 from the trained classifier. For example, a fully convolutional neural network may be used, with 5 layers of artificial neurons, and the output G* of the classifier is obtained as an image representative of the gas emission parameters G. Further, the output G* may correspond to a single image or a value capturing the aggregated behavior of gas emission parameters G over the time series t=1 . . . , T or to a time series of images or values. The output G* may also be representative of one or multiple spectral bands.

Further, the validation data set 540 may be used according to the procedure described herein. Alternatively, the test data set 550 may be used to evaluate the trained classifier. Furthermore, the synthetic positive samples, positive samples, negative samples, and optionally auxiliary data in the testing data set 560 are provided as input data to the trained classifiers 560.

In another embodiment, the output 570 of the trained classifier 560 includes an estimate 572 of the gas emission parameter G. The gas emission parameter G and the classifier's estimate G* are compared and their difference enables the measurement of the performance of the classifiers. More particularly, taking simultaneously into account spectral signals over various bands allows the classifier to robustly estimate gas emission parameters.

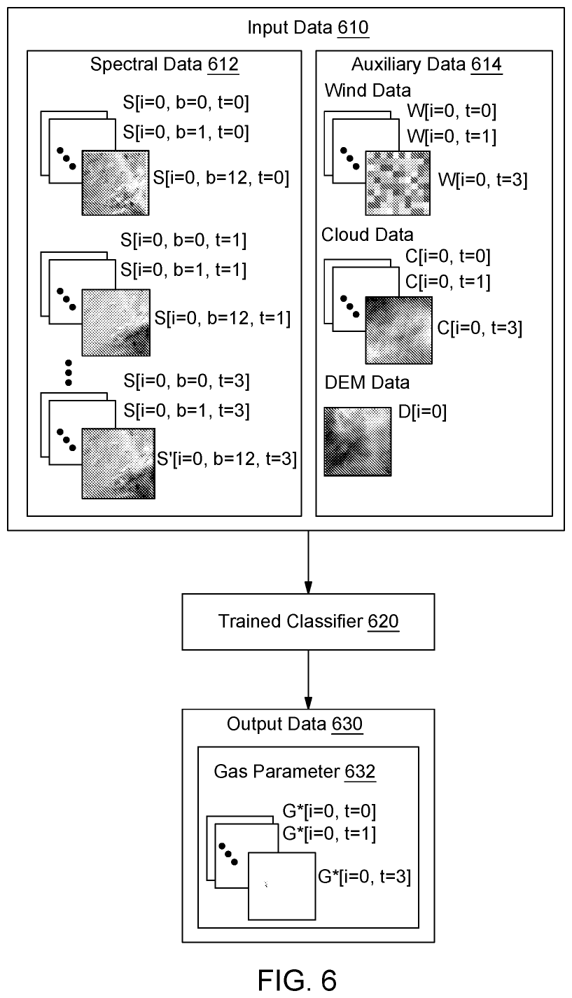

Referring now to FIG. 6, which further illustrates the use of a trained classifier, in accordance with an embodiment of the present disclosure. Once trained as described herein, the classifier may be applied to historical or live spectral signals and associated optional auxiliary data to estimate gas emission parameters of interest. Input data 610 including a time series of spectral signals 612 (sub-divided into multiple spectral bands b) and associated optional auxiliary data 614 within a geophysical are of interest (same as 100 or 410) is used as disclosed.

By way of an example, the region of interest may correspond to an exemplary gas field, the time series is of length 3 (t=1, 2, 3), and the signals used are multispectral signals with discretization in 12 spectral bands (b=1, . . . , 12); and the auxiliary data may include but is not limited to one or more of a wind data, cloud data, and a digital elevation model (DEM), respectively. The spectral data and the associated optional auxiliary data are used as input for a trained classifier 620. The output data 630 thus generated from the trained classifier include an estimated gas emission parameter 632. By way of non-limiting example, the estimated gas emission parameter 632 is representative of estimated reductions in reflectance G* over the same time series (t=1, 2, 3).

In an embodiment, the estimated gas emission parameters 632 may be compared to various processing techniques, such as spectral band ratios computed over the same time series or the geospatial region, to assess that the trained classifier is accurate on historical or live spectral data. Once this step is performed, other processing techniques are no longer needed.

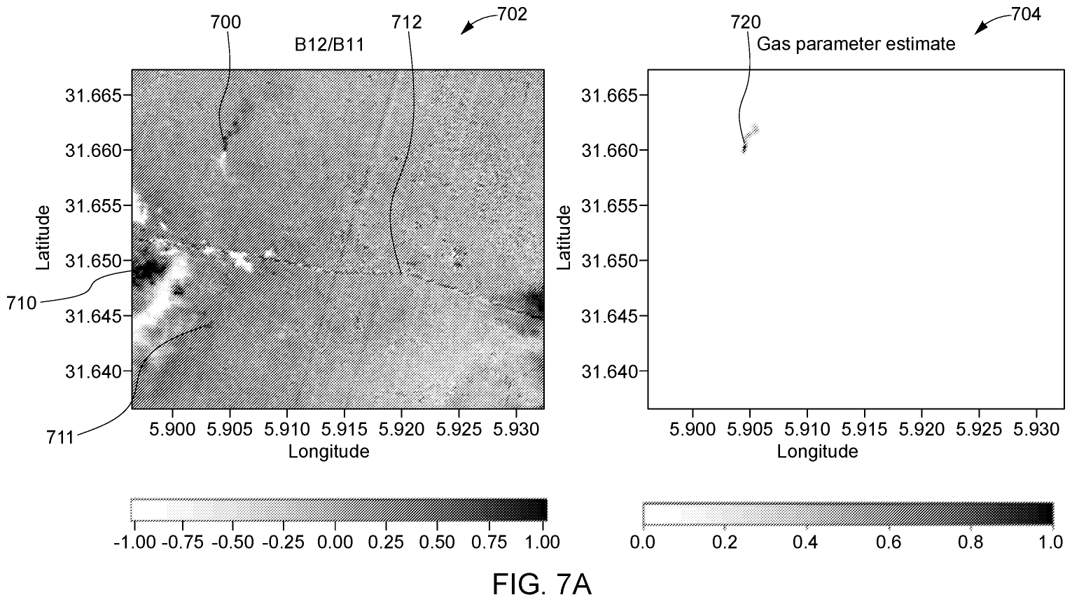

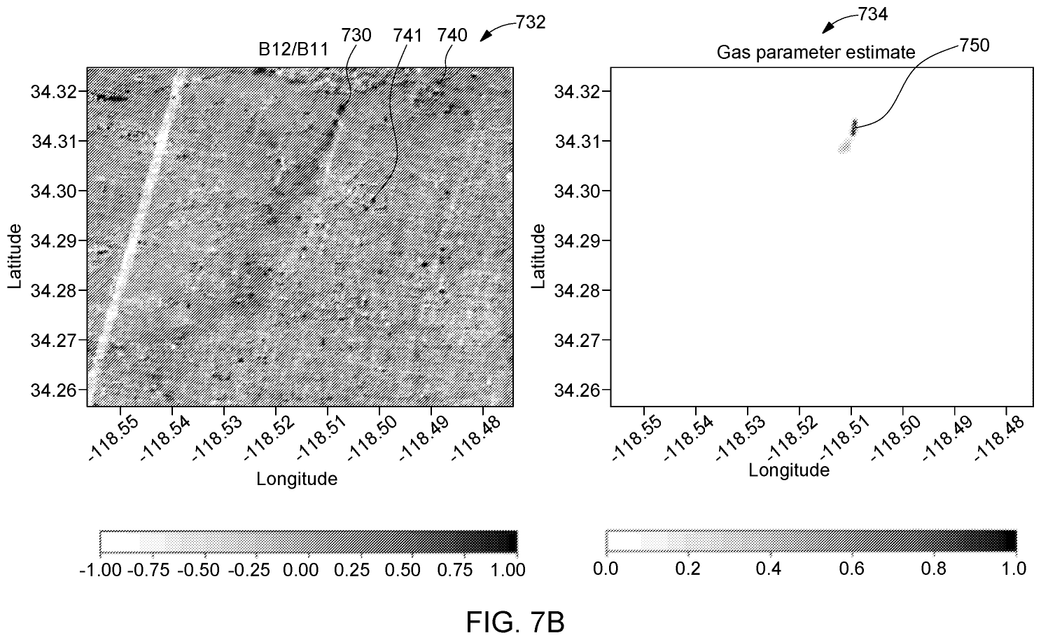

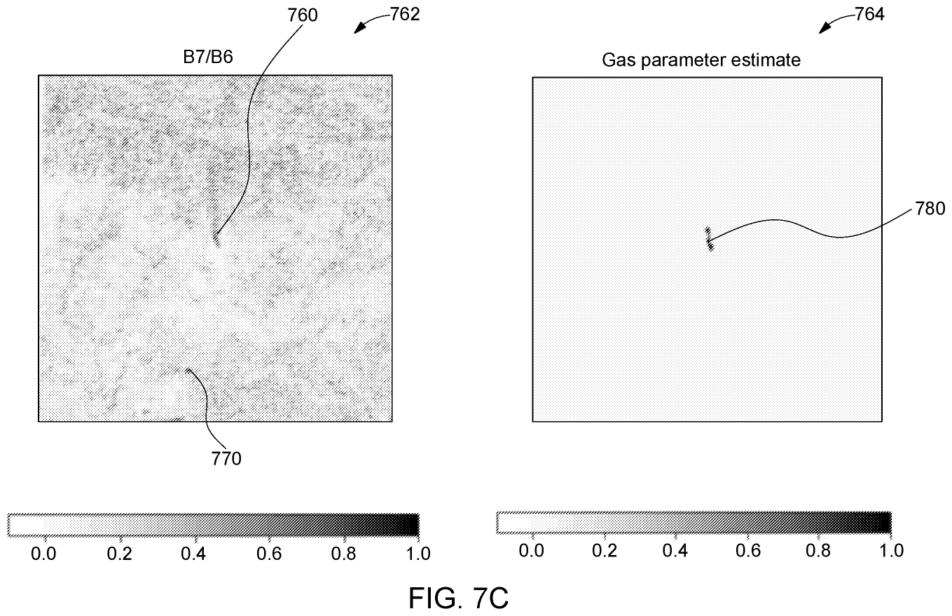

Referring now to FIG. 7A, graphs 702 and 704 illustrating the application of a trained classifier for separating gas reflectance signals measured over a geospatial area of interest when mixed with irrelevant noise signals are depicted, in accordance with an embodiment of the present disclosure. An exemplary application of the trained neural network classifier is implemented on gas emissions, for example, methane gas emissions caused by an unlit flare in the Hassi Messaoud oil field, in Algeria, in 2019, is considered. The classifier has been trained on spectral signals captured by the Sentinel 2 ESA satellite in Northern Algeria, as described herein. Further, graph 702 represents the temporal evolution of the ratio of infrared bands 12 over bands 11, emphasizing the methane gas absorption. Alternatively, the second graph 704, represents the reflectance reduction in band 12 that the trained classifier has identified due to methane gas.

In an exemplary embodiment, the classifier is provided with the spectral signals received from a different geospatial area by the Sentinel 2 ESA satellite, along with auxiliary data of the area, and the outputs of the reduced reflectance due to methane in the infrared band 12 are output. Infrared bands in which methane gas emissions absorb light are depicted in graph 702 (as 700) containing a multitude of other signals (for example absorption from clouds in 710, and absorption from ground features in 711). The trained classifier extracts the reduced reflectance that occurs due to methane (as in 720, which corresponds to the methane absorption signal as can be seen in 700).

Further in FIG. 7B, graphs 732 and 734 depicting the application of the trained classifier for correctly detecting a gas leak over a geospatial area of interest is illustrated, in accordance with an embodiment of the present disclosure. The graph exemplifies the application of the same trained classifier to methane gas emissions occurring from a different geospatial location, for example, due to a reservoir leak from Aliso Canyon, in California in 2015. Like in FIG. 7A, the classifiers are given spectral signals from the Sentinel 2 satellite. The graphs in FIG. 7B illustrates the reflectance reduction caused by absorption due to methane (as in 730) and caused by absorption due to ground features both natural (as in 740) and man-made (as in 741).

The outputs of the infrared reflectance reduction that is due to methane (as in 750, corresponds to the methane absorption signal as can be seen in 730). In FIG. 7A graph 732 illustrates the temporal evolution of the ratio of infrared bands 12 over bands 11, and graph 734 illustrates the reflectance reduction in band 12 that the trained classifier has identified as due to methane.

Referring now to FIG. 7C, graphs 762, and 764 depicting the application of the trained classifier to sensor signals received from a different overhead sensor is illustrated, in accordance with an embodiment of the present disclosure. In the exemplary embodiment, although the application is to the same methane reservoir leak from Aliso Canyon, California in 2015 as in FIG. 7B, still the same trained classifier is applied to the spectral signals captured by a different satellite, for example, the USGS-NASA LandSat-8 satellite is disclosed and illustrated. Further, graph 762, represents the temporal evolution of the ratio of infrared bands 7 over bands 6, and graph 764 represents the reflectance reduction in band 7 that the trained classifier has identified due to methane leaks.

In an embodiment, graph 762 further illustrates 760 as reflectance reduction in this band ratio of band 7 over band 6 that is due to methane absorption from the reservoir leak, while 770 shows similar features due to absorption from ground features. In addition, graph 764 depicts the application of a trained classifier, 780 illustrating the reflectance reduction due to methane only that the trained classifier has isolated and extracted thereof.

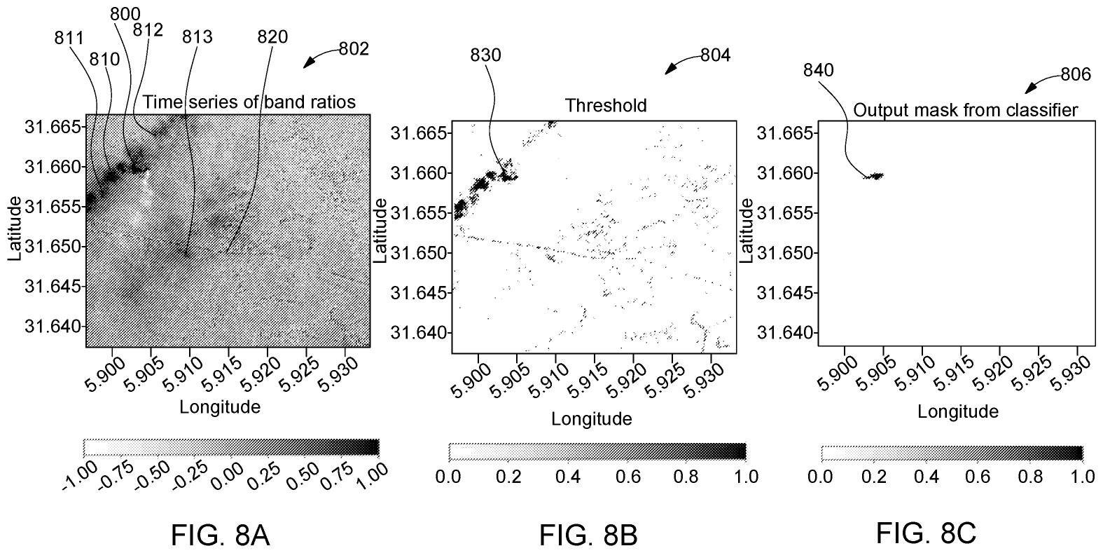

Referring now to FIGS. 8A-8C, graphs 802, 804, and 806, depicting the applications of the trained classifiers to sensor signals from ESA's Sentinel 2 satellite received on a different date are illustrated, in accordance with an embodiment of the present disclosure. The application of the trained classifier to locate and identify the spatial extent of gas emissions is disclosed. In this exemplary embodiment, the same trained classifiers are used to locate any methane gas emissions caused due to the same unlit flare as in FIG. 7A, in the Hassi Messaoud oil field, Algeria, which occurred in 2019, but occurring at a different time as compared with FIG. 7A.

In an embodiment, the spectral signals of the geospatial area are considered as inputs and implemented by the trained classifiers, preferably without the auxiliary data. The trained classifier generates outputs based on the location of the elevated methane gas levels caused due to a gas emissions source. By way of an example for generating a mask output, having values of 1 (where the classifier finds methane), or 0 (where the classifier does not find methane) respectively.

In FIG. 8A, graph 802 represents the temporal evolution of the ratio of infrared bands 12 over band 11, which may directly be used to locate methane gas by applying a threshold, is disclosed. In graph 802, exemplary point 800 shows the reflectance reduction that is caused due to methane gas absorption from the emissions, while 810, 811, 812, and 813 show similar features, but those are obtained due to gas absorption from the clouds. Further, 820 shows similar features that are due to ground features (for example change in infrared light absorption from a road).

In FIG. 8B, graph 804 depicts a threshold on the temporal evolution of the ratio of infrared bands 12 over band 11, which are generally manually picked such that the location of the methane leak is emphasized. In this threshold data, the real methane gas leak location is in 830 and the rest are false positives.

Further, as shown in FIG. 8C, graph 806 depicts the location determined using the trained classifier. The portion of the methane gas location mask with values of 1 is shown as 840 (indicative of the presence of emission) and estimated by the trained classifier, which is devoid of false positives.

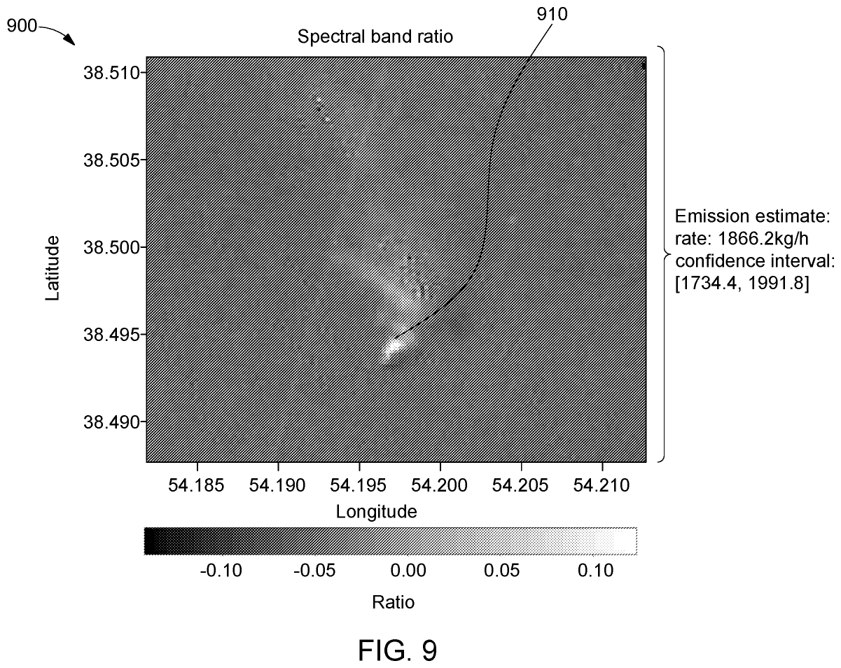

In another embodiment, referring now to FIG. 9, graph 900 shows the application of the trained classifier for estimating an emission rate, and the associated interval is illustrated, in accordance with an embodiment of the present disclosure. The use of a trained classifier to estimate a gas emission rate is illustrated in 900. In this exemplary embodiment, the trained classifier is applied to synthetic spectral signals corresponding to an exemplary geospatial area such as the geospatial area based in Turkmenistan 910 showing the reflectance reduction that is due to methane gas absorption from the gas emissions.

Further, the synthetic spectral signals of the geospatial area are taken as input by the trained classifier, to which a plume mask, as in FIG. 8 is applied. The trained classifier outputs a scalar value. The output scalar value may correspond to an estimate of the gas emission rate. Further, the model also outputs a confidence interval for the corresponding gas emission rate.

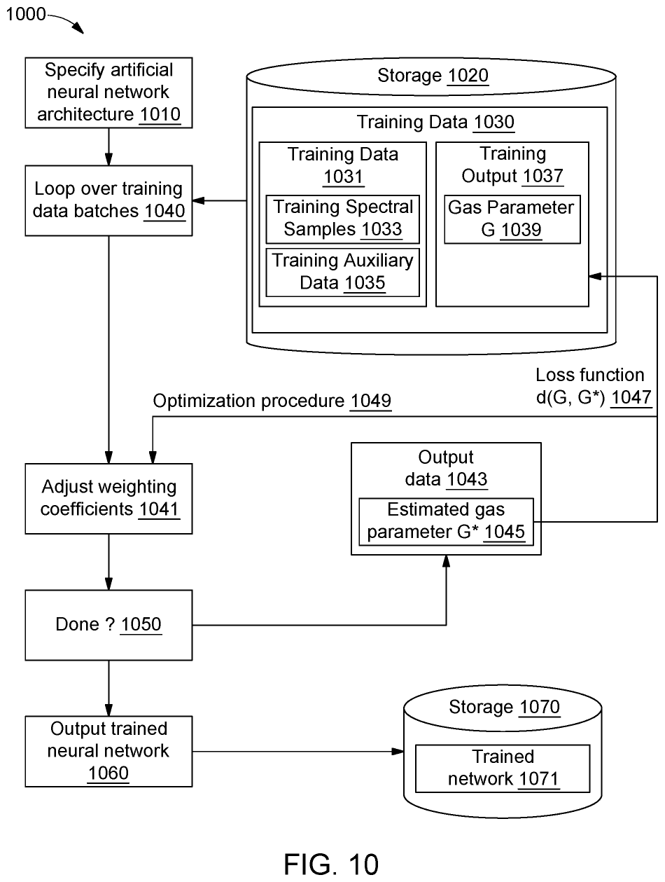

Referring now to FIG. 10, showing a flowchart 1000 of an exemplary method for training a neural network classifier is illustrated, in accordance with an embodiment of the present disclosure. The exemplary method for training the neural network begins with structure 1010 which is first specified for the neural network. The specified structure 1010 corresponds to setting up an initial “architecture” referring to a number of artificial neurons, the operations they perform, and their connectivity, and an exemplary arrangement of such artificial neurons in various layers, and a pre-specified series of filtering, embeddings, or non-linear operations thereof. The coefficients associated with the various operations applied at the various layers may be selected through an optimization procedure, such as stochastic gradient descent, as described elsewhere herein.

Further, a storage device 1020 comprising one or more training data 1030 (for example a corpus of training samples) may be used to train the neural networks. The training data 1030 may further be subdivided into input training data 1031 and output training data 1037. The input training data 1031 corresponds to the data which is provided as an input of the neural network. The input training data may further include training samples 1033 derived from spectral signals and auxiliary data 1035 (as described elsewhere herein). The output training data 1037 includes associated values G of the gas emission parameters 1039 of interest.

Further, the input training data 1031, may be organized in several small fractions, generally in the form of “batches”, and may be used sequentially as input to the neural network. It is to be noted that at each loop iteration 1040, a fraction of the training data is used to adjust the parameters 1041 of the operations performed by the artificial neurons of the network. The neural network uses the fraction of the training data to produce a training output 1043, which includes an estimate G* of gas emission parameter 1045. The estimate of the gas emission parameter 1045 is compared to the associated training gas parameter 1039 through the computation of a distance 1047, d(G, G*), often termed a “loss function”.

The loss function may include but is not limited to the cross-entropy function, mean squared error function, mean absolute error function, or any other such functions thereof. In an embodiment, a mathematical optimization procedure 1049 generally the “minimization” or “maximization” operations, are used for adjusting the parameters 1041 of the operations performed by the neural network. The parameters adjustment is performed such that the distance d(G, G*) becomes as small as possible or as large as possible, respectively. By way of an example, the optimization procedure may include any one of a stochastic gradient descent, a conditional gradient descent, a quasi-Newton optimization technique, or any other such known techniques thereof.

Once a pre-defined criterion 1050 is reached in method 1000, loop 1040 may stop. For example, pre-defined criteria 1050 may include reaching a distance d(G, G*) smaller than a pre-determined threshold, or has analyzed a pre-determined number of batches of the training data or reaches a maximum or a minimum on an additional validation dataset. Therefore, the end of the iterative loop 1040 results in an output-trained neural network 1060. A second storage device 1070, may be configured for storing an associated trained neural network 1071. The storage device 1020 or 1070, maybe a non-transitory computer-readable storage media.

As the optimization is performed iteratively, the performance of the classifier may regularly be assessed based on a separate validation set which is separate and not directly used to optimize the classifier's parameters. In addition, the final set of hyperparameters and the architecture of classifier that is used operationally is the model that achieves optimal performance on the validation data set.

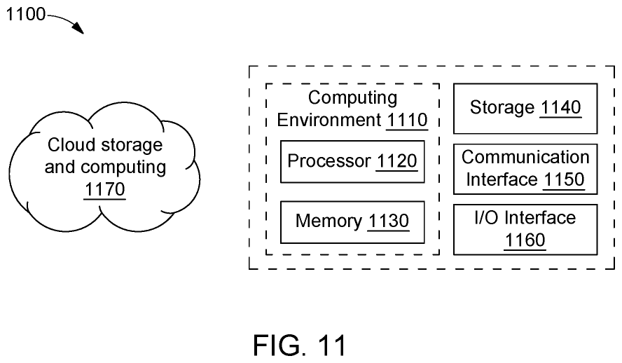

In an exemplary embodiment, referring to FIG. 11, illustrating a flowchart 1100 of an exemplary computing environment using which the disclosed method can be implemented, in accordance with various embodiments of the present disclosure. An exemplary computing environment 1100 which can be used to implement various techniques are illustrated, as described herein. The computing environment 1110 includes a processor 1120 executing the computer-executable instructions, and a memory 1130.

In an exemplary embodiment, processor 1120 may correspond to a single processor or a virtual processor, or many multiple processors or processing units, thereof. The processing units may include but are not limited to CPUs or GPUs. Further, the processor may retrieve computer-executable instructions from memory 1130, storage 1140, or internal cache memory.

Further, memory 1130 may be internal or distributed. Memory 1130 may correspond to one or more volatile or non-volatile memory. The memory may include but are not limited to registers, RAM, cache, ROM, solid-state drive (SSD), electrically erasable programmable read-only memory (EEPROM), phase-change memory (PCM), or other types of data storage. The implementing software and the data sets used for implementing the processes as described elsewhere herein can be stored on memory 1130.

In an additional embodiment, the computer environment 1100 may include other features such as storage 1140, a communication interface 1150, and an input/output interface 1160. The components of the computing environment may be coupled by way of an interconnection mechanism or communication infrastructure (not shown). The storage media 1140 as described herein, may correspond to a removable or a non-removable non-transitory storage media, which may be an external or internal associated with the computing environment 1100. The storage media 1140 may include but is not limited to one or more of a hard disk drive (HDD), a solid-state disk (SSD), magnetic tapes, magnetic cassettes, DVDs, USB, magneto-optical discs, or any other storage medium thereof, which may be accessible within the computing environment 1100. Software and data used to implement the procedures as described herein may be stored on the storage media 1140.

Further, computer-readable media are typically the media accessible within the computing environment 1100, such as the memory 1030 and the storage 1140. The computer environment 1100 can further include a measurement acquisition system, a peripheral controller, or a bus coupling component (not shown).

Further, the communication interface 1150 includes hardware or software enabling communication between the computer environment 1100 and one or more other computing entities. By way of non-limiting examples, the communication interface 1150 may include a wireless adapter, a network adapter enabling communication with wired-based networks, or a network interface controller thereof. The communication interface 1150 may be configured to convey information such as graphical data, computer-executable instructions, or other data signals.

By way of an example, the input or output (“I/O”) devices or interfaces 1160 are configured. These devices may include devices that provide input to and receive output from the computing environment 1100. By way of non-limiting examples, input devices or interfaces may include one or more touch input devices such as a keyboard or a touch screen, a modem, a scanning device, a network interface, a data acquisition system, or another input device. The output devices may include but are not limited to one or more of a display, a speaker, a graphic engine, a printer, an output driver, an audio driver, or any other device providing an output from the computer environment 1100 thereof. The output device or output interface may be configured to display or render the data to a user.

The computing environment 1100 is outlined in the context of representative embodiments and is not intended to be limiting in any way. Other computer system configurations may be used to implement the disclosed technology, including one or more supercomputers, mini-computers, network PCs, hand-held computational devices, or other computing devices thereof. Distributed computing environments relying on remote processing devices may also be used in the process of the present disclosure.

In an embodiment, one or more exemplary processes may be performed by the way of a computing cloud 1170. A “computing cloud” corresponds to a model allowing for on-demand network access to shared computing resources. For example, executable instructions implementing the training of a classifier may be performed in a computing cloud 1170. Also, the non-transitory computer-readable medium in the computing cloud may be used to store or access the received signals, or other auxiliary data, or computer-executable instructions thereof.

The singular “a”, “the”, and “an” used herein includes the associated plural forms unless the context indicates otherwise. The term “or” is inclusive, unless specified otherwise or indicated by context. The term “and/or” refers to any item or combination thereof. Terms used to describe the disclosed methods, like “generate”, “estimate”. “classify”, “input”, “output”, “neural network”, “analyze”, “build”, “receive”, “filter”, “embedding”, “determine”, “train”, “analyze”, “sample”, or “obtain” are abstractions of the operations performed and are intended to encompass commonly used variations of the techniques. The actual operations corresponding to these terms can vary according to the implementation and are discernable by one skilled in the art. As used herein, the term “coupled” refers to any practical way of linking or coupling elements together, including through intermediary components. The term “includes” means “comprise”.

The computer-executable instructions described herein can be part of one or more of a software library or a software application and are not limited to any specific computer program or language. By way of a non-limiting example, the software implementing the disclosed technology can be written in Python, Julia, C, C++, R, Fortran, or any other programming language. By way of a non-limiting example, the deep learning classification model can be implemented as a neural network in Pytorch, Tensorflow, Theano, DL4J, and Caffe or as a shallow classifier in Scikit-learn, Shogun, and H2O. The software-based embodiments can be remotely accessed, uploaded, or downloaded, through a communication network, interface, or device. By way of non-limiting example, a suitable communication network, interface, or device includes the Internet, an intranet, the World Wide Web, or other such communication networks, interfaces, or devices.

The computer-executable instructions described herein can be executed on a local computer or in a network environment (such as a cloud-computing environment, a local computing network environment, or another such network). The disclosed processes are not limited to any specific type of hardware.

The principles of operation, scientific theories, and other principles and methods described therein have been provided with the intent of providing a better explanation and understanding of the disclosure and are not intended to be limiting in any way. The methods and systems in the appended claims are not limited by such principles of operations, scientific theories, and other principles and methods.

The various examples illustrated in the detailed description and accompanying drawings can be modified without departing from such principles of operation. These examples correspond to preferred examples of the disclosure herein and are not intended to limit the scope of the claimed subject matter. We claim as our invention all such embodiments, that fall within the scope of the appended claims and equivalents thereto.

1. A method for determining gas emission parameters over a geospatial area, comprising:
obtaining, by a computing node and from one or more overhead sensors, one or more spectral signals over the geospatial area in three or more different spectral bands and at two or more different time-periods;
determining, by the computing node, one or more gas emission parameters over the geospatial area based on the one or more spectral signals using one or more trained deep-learning classification models, wherein each of the one or more trained deep-learning classification models is generated by:
generating training data based on training samples representative of historical spectral signals from one or more geospatial areas, wherein the training samples comprise one or more positive samples representative of a presence of gas emissions and zero or more negative samples representative of an absence of gas emissions;
forming a set of training data batches, wherein each training data batch comprises a part of the training data;
training a deep learning classification model based on the set of training data batches.

2. The method of claim 1, wherein the one or more spectral signals comprises one or more of reflectance signals, absorbance signals, radiance signals, transmittance signals, a ratio of reflectance signals in different spectral bands, a ratio of radiance signals in different spectral bands, a ratio of absorbance signals in different spectral bands, a temporal variation, spatial variation, or spectral variation of one or more of reflectance signals, absorbance signals, radiance signals, transmittance signals, or any combination thereof.

3. The method of claim 1, wherein the one or more spectral signals correspond to a time series of spectral signals or a temporal difference of spectral signals.

4. The method of claim 1, wherein the positive samples comprise synthetic positive samples generated by superimposing simulated gas emission to one or more of the positive samples or the negative samples.

5. The method of claim 1, wherein the one or more gas emission parameters are selected from at least one of reflectance, a radiance, an absorbance, a transmittance, a gas spatial distribution, a source location for gas emissions, a mass, a volume, a gas emission rate, a gas concentration, or a temporal or a spatial variation thereof.

6. The method of claim 1, wherein the training samples are pre-processed to extract signal parameters or features, wherein pre-processing comprises applying at least one of a normalization, a cropping, a rotation, a noise addition, an embedding, a denoising, a filtering, a statistical ratio, a density estimation, a differentiation analysis, a translation of the spectral signal, or another linear or non-linear operation thereof.

7. The method of claim 1, wherein the training data further comprises auxiliary data, and wherein the auxiliary data is selected from at least one of: data from the spectral signal obtained at a different time, data from a different spectral signal, topography data, weather data, wind data, cloud data, digital elevation model, thermal data, optical data, albedo data, SAR data, or InSAR data, bottom-of-atmosphere reflectance data, or a time series thereof.

8. The method of claim 1, further comprising rendering the one or more gas emission parameters to a user via a graphic user interface (GUI), a message notification, or an alert, and wherein the alert or the message notification is generated based on a value of at least one of the one or more gas emission parameters.

9. (canceled)

10. The method of claim 1, wherein the one or more overhead sensors is mounted on an overhead device selected from at least one of a multi-spectral satellite or a hyperspectral satellite, a drone, a balloon, a plane, an unmanned aircraft, an unmanned aerial vehicle, a remotely piloted vehicle, an uncrewed aerial vehicle, an unmanned spaceship, or any other macro or micro air vehicles thereof.

11. A system for determining gas emission parameters over a geospatial area, comprising:
a non-transitory computer-readable media for storing one or more spectral signals received from one or more overhead sensors over the geospatial area at two or more different time-periods, one or more trained deep-learning classification models, and processor-executable instructions;
at least one computing node comprising one or more processors, wherein the at least one computing node is operatively coupled to the non-transitory computer-readable medium, and wherein the processor executable instructions, when executed by the one or more processors, caused the one or more processors to:
determine one or more gas emission parameters over the geospatial area based on the one or more spectral signals using one or more trained deep-learning classification models, wherein each of the one or more trained deep-learning classification models is generated by:
generating training data based on training samples representative of historical spectral signals from one or more geospatial areas, wherein the training samples comprise one or more positive samples representative of a presence of gas emissions and zero or more negative samples representative of an absence of gas emissions;
forming a set of training data batches, wherein each training data batch comprises a part of the training data;
training a deep learning classification model based on the set of training data batches.

12. The system of claim 11, wherein the one or more spectral signals are measured at one or more different wavelengths, and wherein the spectral signals correspond to one or more of a time series of spectral signals or a temporal difference of spectral signals.

13. The system of claim 11, wherein the positive samples comprise synthetic positive samples generated by superimposing simulated gas emission to one or more of the positive samples or the negative samples.

14. The system of claim 11, wherein the one or more gas emission parameters are selected from at least one of a reflectance, a radiance, an absorbance, a transmittance, a gas spatial distribution, a source location for gas emissions, a mass, a volume, a gas emission rate, a gas concentration, or a temporal or a spatial variation thereof.

15. The system of claim 11, further comprising a user device to render the one or more gas emission parameters to a user via a GUI, a message notification, or an alert, and wherein the alert or the message notification is generated based on a value of at least one of the one or more gas emission parameters.

16. The method of claim 1, wherein the positive samples comprise synthetic positive samples generated by superimposing gas emission data generated by a machine learning model to one or more of the positive examples or the negative samples, or target synthetic gas emission parameters generated by a machine learning model.

17. The method of claim 1, wherein the positive samples comprise synthetic positive samples generated by superimposing gas emission data to samples based on natural gas emission, or synthetic positive samples generated from examples of natural gas emissions through linear or non-linear operations.

18. The method of claim 1, wherein the positive samples comprise synthetic positive samples that include synthetic target gas emission parameters, wherein the synthetic target gas emission parameters correspond to gas emission parameters generated using a numerical model or a physical model.

19. The method of claim 1, wherein the geospatial area comprises one or more of an oil and gas extraction site, an oil and gas well or well pad, a power plant, a wastewater plant, a landfill, a mine, an agriculture area or wetlands.

20. The method of claim 1, wherein the geospatial area comprises one or more of an oil and gas storage, an oil and gas transport, or an oil and gas refining piece of equipment or infrastructure.

21. The method of claim 1, wherein the geospatial area comprises a flare stack or a compressor.
